(19) United States
(12) Patent Application Publication
(10) Pub. No.: US 2004/0202329 A1
(43) Pub. Date: Oct. 14, 2004

(54) Method and system for providing broadcast service using encryption in a mobile communication system

(75) Inventors: Jung-Soo Jung, Seoul (KR); Dae-Gyun Kim, Seongnam-si (KR); Beom-Sik Bae, Suwon-si (KR); Jun-Hyuk Song, Anyang-si (KR); Yong Chang, Seongnam-si (KR); Nae-Hyun Lim, Seoul (KR); Do-Jun Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/822,068

(22) Filed: Apr. 9, 2004

(30) Foreign Application Priority Data
Apr. 11, 2003 (KR) 23129-2003
Apr. 11, 2003 (KR) 23002-2003

(51) Int. Cl. H04Q 7/20

(52) U.S. Cl. 380/273

(57) ABSTRACT

Disclosed is a method and system for providing a broadcast service to a mobile station over a radio channel in a mobile communication system. A base station determines whether a mask key is requested by a mobile station, based on a predetermined registration identifier included in a registration message received from the mobile station, and transmits a currently valid mask key only when it is determined that another mask key is requested by the mobile station. The base station transmits another mask key to be used next, or transmits another mask key to be used next, together with the currently valid mask key, if the registration message was received within a predetermined skew time before a lifetime of the currently valid mask key expires.

### PRIORITY

This application claims priority under 35 U.S.C. § 119 to applications both entitled “Method for Providing Broadcast Service Using Encryption in a Mobile Communication System” and filed in the Korean Intellectual Property Office on Apr. 11, 2003 and assigned Serial Nos. 2003-23129 and 2003-23002, the contents of which are incorporated herein by reference.

### BACKGROUND OF THE INVENTION

1. Field of the Invention

The present invention relates generally to a mobile communication system and a service method thereof, and in particular, to a method for providing a broadcast service to a mobile station over a radio channel and a system therefor.

2. Description of the Related Art

Communication systems are rapidly changing, blurring the distinction of wire/wireless area and the distinction of region and country. In particular, a communication system such as IMT-2000 (International Mobile Telecommunication 2000) can collectively provide various information desired by a user as well as video and sound information on a real-time basis. With the development of mobile communication technology, existing mobile communication systems which enable users to simply perform voice communication using a mobile station (MS) such as a cellular phone or a personal communications system (PCS) phone have evolved into advanced mobile communication systems capable of enabling users to not only transmit text information, but also to view a broadcast service.

In a conventional mobile communication system, transmission of broadcast data has been achieved by unicast. Unicast causes an increase in system load due to a waste of resources in the system and a radio link because in the broadcast service, the same data must be transmitted to a plurality of mobile stations.

The current 3^{rd} Generation Partnership Project 2 (3GPP2) is considering various service media and efficient resource utilization for a broadcast service in mobile communication systems. In the broadcast service, a base station (BS) unicasts high-rate forward data to a mobile station without reverse feedback information from the mobile station. The broadcast service is similar in concept to the general television broadcast service. Herein, a mobile communication system providing the broadcast service will be referred to as a “broadcast service system.”

In the case of a non-commercial broadcast service, a plurality of unspecified mobile stations access a forward (or downlink) traffic channel from a base station. However, in order to provide a commercial television broadcast service to users while maintaining economic profitability, the broadcast service system must allow only authenticated mobile stations to receive broadcast data and prevent unauthenticated mobile stations from receiving the broadcast data. Further, the broadcast service system must measure a time for which the authorized mobile stations have used the broadcast service, to perform correct accounting. However, conventional broadcast service systems cannot control a time for which mobile stations use the broadcast service. Therefore, conventional broadcast service systems cannot provide efficient accounting.

### SUMMARY OF THE INVENTION

It is, therefore, an object of the present invention to provide a broadcast service method for reducing system congestion by simplifying registration and/or accounting procedures of a mobile station in providing a broadcast service only to a normally registered mobile station in a broadcast service system, and a system therefor.

It is another object of the present invention to provide a broadcast service method for securing efficient time-based accounting by simplifying registration and/or accounting procedures of a mobile station using a broadcast service.

According to a first aspect of the present invention, in a mobile communication system for providing a broadcast service to a plurality of mobile stations over a radio channel, wherein broadcast data is encrypted with predetermined encryption information and provided to the mobile station, there is provided a method for receiving a broadcast service in the mobile station, comprising the steps of generating a registration message including a predetermined registration identifier for identification of the encryption information, and transmitting the generated registration message to a base station; receiving updated encryption information for decryption of the broadcast data from the base station; and updating the registration identifier based on the updated encryption information.

According to a second aspect of the present invention, in a mobile communication system for providing a broadcast service to a plurality of mobile stations over a radio channel, there is provided a method for providing by a base station a broadcast service to the mobile station, comprising the steps of receiving a registration message transmitted from the mobile station; determining whether a registration identifier for identification of encryption information required for decryption of broadcast data is included in the registration message, and determining whether it is necessary to transmit updated encryption information to the mobile station; and transmitting the updated encryption information to the mobile station according to the determination result.

According to a third aspect of the present invention, in a mobile communication system for providing a broadcast service to a plurality of mobile stations over a radio channel, wherein broadcast data is encrypted with predetermined encryption information and provided to the mobile station, there is provided a method for receiving a broadcast service in the mobile station, comprising the steps of generating a registration message including a predetermined mask key request bit for requesting transmission of the predetermined mask key for decryption of broadcast data and transmitting the generated registration message to a base station while the mobile station is using a broadcast service; and receiving the encryption information including the predetermined mask key and lifetime information of the predetermined mask key from the base station based on the mask key request bit.

According to a fourth aspect of the present invention, in a mobile communication system for providing a broadcast service to a plurality of mobile stations over a radio channel, there is provided a method for providing by a base station a broadcast service to the mobile station, comprising the steps of receiving a registration message including a predetermined mask key request bit for requesting transmission of the predetermined mask key for decryption of broadcast data, from the mobile station; analyzing a value of the predetermined mask key request bit to determine whether to transmit the encryption information including the predetermined mask key and lifetime information of the predetermined mask key; and transmitting the encryption information to the mobile station when the base station determines to transmit the encryption information.

According to a fifth aspect of the present invention, in a mobile communication system for providing a broadcast service to a plurality of mobile stations over a radio channel, there is provided a method for providing by a base station a broadcast service to the mobile station, comprising the steps of receiving a registration message including a predetermined mask key request bit for requesting transmission of the predetermined mask key for decryption of broadcast data, from the mobile station; analyzing a value of the predetermined mask key request bit to determine whether to transmit the encryption information including the predetermined mask key and lifetime information of the predetermined mask key; and transmitting the encryption information to the mobile station when the base station determines to transmit the encryption information.

According to a sixth aspect of the present invention, in a mobile communication system for providing a broadcast service to a plurality of mobile stations over a radio channel, there is provided a method for providing by a base station a broadcast service to the mobile station, comprising the steps of receiving a registration message for use of a broadcast service by the mobile station; and transmitting current encryption information and next encryption information including their lifetimes to the mobile station if it is determined that the registration message was received within a predetermined skew time before the lifetime of the current encryption information expires.

According to a seventh aspect of the present invention, in a mobile communication system including a base station for providing a broadcast service to a plurality of mobile stations over a radio channel and a packet data service node for connecting the base station to a content server via a packet data network, wherein broadcast data is encrypted with predetermined encryption information and provided to the mobile station, there is provided a broadcast service method comprising the steps of transmitting, by the mobile station, a first registration message for initial use of a broadcast service to the base station; upon receiving the first registration message, transmitting by the base station the encryption information for decryption of the broadcast data to the mobile station; upon receiving the encryption information, generating by the mobile station a predetermined registration identifier which is identification information of the encryption information; generating by the mobile station a second registration message including the registration identifier and transmitting the generated second registration message to the base station if second or later registration for use of the broadcast service by the mobile station is required; comparing by the base station the registration identifier included in the second registration message with a registration identifier of encryption information currently registered in the base station; and transmitting updated encryption information to the mobile station if it is determined that the two registration identifiers are different from each other.

According to an eighth aspect of the present invention, there is provided a broadcast service system including a base station for providing a broadcast service to a plurality of mobile stations over a radio channel and a packet data service node for connecting the base station to a content server via a packet data network, wherein broadcast data is encrypted with predetermined encryption information and provided to the mobile station, the system comprising at least one mobile station connected to the base station through the radio channel, for performing location registration for use of a broadcast service, decrypting the broadcast data using the encryption information transmitted via the base station while using the broadcast service, generating a predetermined registration identifier as identification information of the encryption information, and transmitting the generated registration identifier to the base station; and at least one base station for transmitting to the mobile station broadcast data transmitted via the packet data service node while the mobile station is using the broadcast service, receiving a predetermined registration message transmitted during location registration of the mobile station, analyzing a registration identifier of the encryption information included in the registration message, and determining whether to update the encryption information for the mobile station according to the analysis result.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a network configuration of a broadcast service system to which the present invention is applied;

FIG. 2 is a diagram illustrating a protocol stack of the broadcast service system shown in FIG. 1;

FIG. 3 is a message flow diagram illustrating a broadcast service procedure performed between a mobile station and a base station in a broadcast service system to which the present invention is applied;

FIG. 4 illustrates a data format of a registration message used for a broadcast service by a mobile station in a broadcast service system to which the present invention is applied;

FIG. 5 is a message flow diagram illustrating a broadcast service procedure provided in a broadcast service system to which the present invention is applied;

FIG. 6 is a message flow diagram illustrating a procedure for registering a mobile station by a base station in a broadcast service system to which the present invention is applied;

FIG. 7 is a message flow diagram illustrating a procedure for registering a mobile station through a packet data service node in a broadcast service system to which the present invention is applied;

FIG. 8 illustrates a format of a registration message including related information of a mask key according to a first embodiment of the present invention;

FIG. 9 is a message flow diagram illustrating a broadcast service procedure for registering a mobile station using a hash value of a mask key according to a first embodiment of the present invention;

FIG. 10 illustrates a format of a registration message including a sequence number of a mask key according to a modified embodiment of the present invention;

FIG. 11 illustrates a format of a registration message including a mask key request bit according to another modified embodiment of the present invention;

FIG. 12 is a flowchart illustrating a registration procedure by a mobile station using a registration ID according to a first embodiment of the present invention;

FIG. 13 is a flowchart illustrating a registration procedure by a base station using a registration ID according to a first embodiment of the present invention;

FIG. 14 is a message flow diagram illustrating a broadcast service method using a skew time according to a second embodiment of the present invention;

FIG. 15 illustrates a format of a data burst message including a current mask key and a next mask key according to a second embodiment of the present invention; and

FIG. 16 illustrates a format of an encryption information message including a current mask key and a next mask key according to a second embodiment of the present invention.

### DETAILED DESCRIPTION OF THE PREFERRED EMBODIMENTS

Several preferred embodiments of the present invention will now be described in detail with reference to the annexed drawings. In the following description, a detailed description of known functions and configurations incorporated herein has been omitted for conciseness.

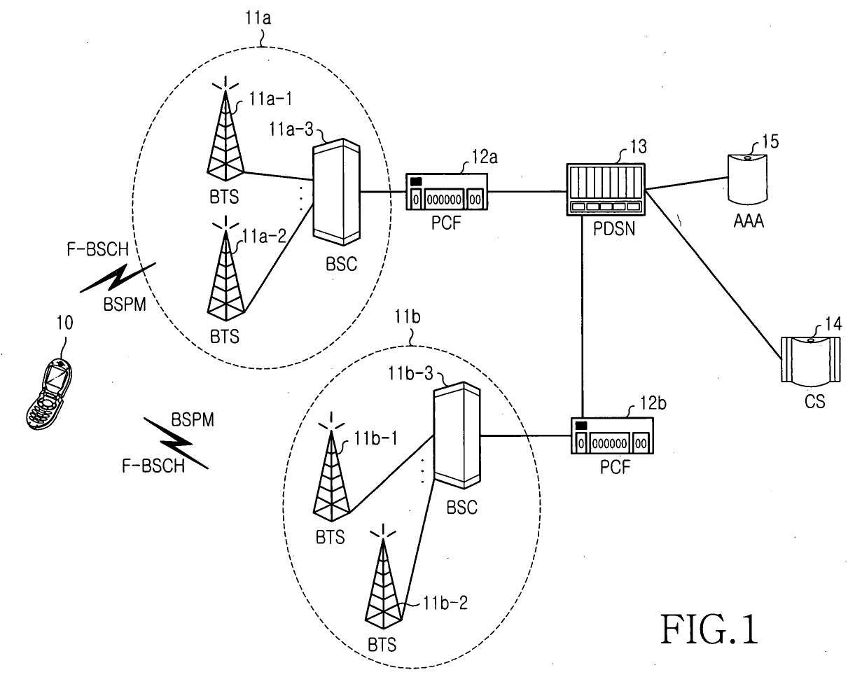

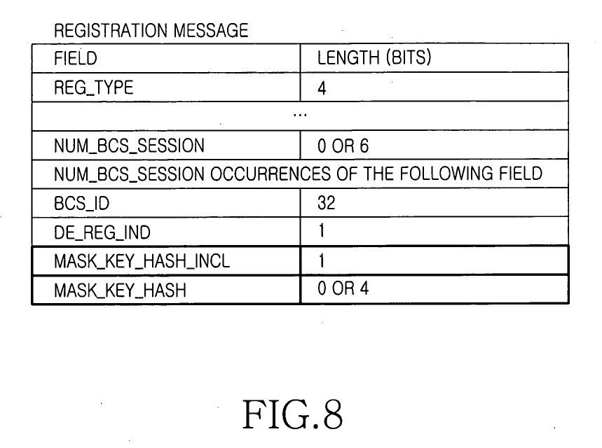

Herein, a broadcast service system to which the present invention is applied and a broadcast service method over the system will be described with reference to FIGS. 1 to 7, and a broadcast service system according to an embodiment of the present invention and a broadcast service method thereof will be described with reference to FIGS. 8 to 16.

FIG. 1 is a diagram illustrating a network configuration of a broadcast service system to which the present invention is applied. Referring to FIG. 1, broadcast data including video and/or sound information for a broadcast service provided from a broadcasting service server or content server (CS) 14 is forwarded to base stations (BS) 11a and 11b via a packet data service node (PDSN) 13. When the content server 14 is connected to the packet data service node 13 via a packet communication network such as the Internet, the broadcast data is generated in the form of a compressed Internet Protocol (IP) packet.

The packet data service node 13 receives user profile information for authentication of packet communications from an authentication, authorization and accounting (AAA) server 15, generates accounting information for a broadcast service, and provides the generated accounting information to the AAA server 15. The base stations 11a and 11b include base transceiver subsystems (BTSs) 11a-1, 11a-2, 11b-a and 11b-2, and base station controllers (BSCs) 11a-3 and 11b-3, well known in the field of cellular mobile communication technology, and are connected to the packet data service node 13 via packet control function blocks (PCFs) 12a and 12b, respectively.

For example, IP multicast technology is used to send broadcast data provided from the content server 14 to the base stations 11a and 11b. The base stations 11a and 11b constitute a multicast group that receives IP multicast data from the content server 14. Membership information of the multicast group is held by individual multicast routers (MRs)(not shown) connected to the base stations 11a and 11b.

The IP multicast data generated from the content server 14 is multicast to the base stations 11a and 11b constituting a multicast group, and the base stations 11a and 11b convert the IP multicast data into radio frequency (RF) signals, and transmit the RF signals in their service areas.

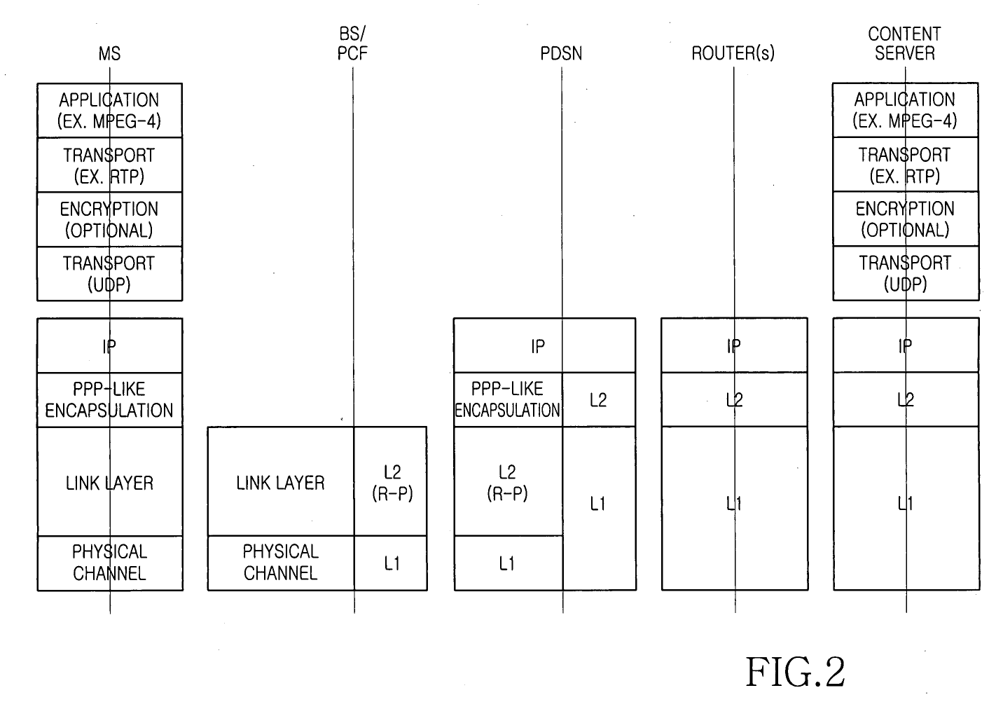

FIG. 2 is a diagram illustrating a protocol stack of the broadcast service system shown in FIG. 1. Herein, the term “layer” refers to software or hardware that performs an operation according to a corresponding protocol.

Referring to FIG. 2, a Mobile Station (MS) receiving a broadcast service through an Internet protocol is based on a physical layer and a Medium Access Control (MAC) layer of Layer 1 (L1), a link layer and a Point-to-Point Protocol (PPP) layer of Layer 2 (L2), and an IP layer of Layer 3 (L3). The MS further includes a transport layer for supporting a User Datagram Protocol (UDP) and a Real-Time Protocol (RTP), and an application layer for supporting Moving Picture Experts Group-4 (MPEG-4).

A BS/PCF is comprised of a physical layer and a link layer for communication with the mobile station, and Layer 1 and Layer 2 for communication with a Packet Data Service Node (PDSN). The PDSN is based on Layer 1, Layer 2 and a PPP layer for communication with the BS/PCF, and Layer 1 and Layer 2 for communication with a packet data network, and further includes an IP layer. A content server is based on Layer 1, Layer 2 and an IP layer for communication with the packet data network comprised of at least one router, and further includes an application layer supporting MPEG-4 and a transport layer to generate broadcast data to be provided to the mobile station and transport the generated broadcast data.

When separate encryption is additionally used between the content server and the mobile station, the content server and the mobile station include an encryption layer for encryption and decryption of broadcast data.

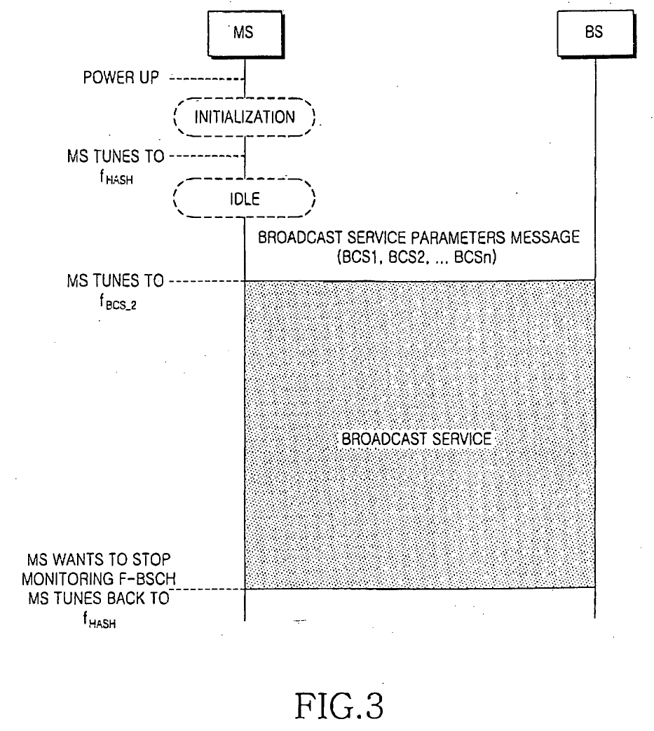

FIG. 3 is a message flow diagram illustrating a broadcast service procedure performed between a mobile station and a base station in a broadcast service system to which the present invention is applied.

Referring to FIG. 3, upon power up, a mobile station (MS) performs initialization and then acquires session information for a broadcast service by receiving a Broadcast Service Parameter Message (BSPM) transmitted by a Base Station (BS) over a common channel through a frequency band f_{HASH} to which it is tuned, in order to receive the broadcast service. The BSPM includes broadcast service parameters, such as frequency and code information of a physical channel for a broadcast service and broadcast service identifiers (BCS IDs) indicating broadcast services that can be provided in the base station. The mobile station determines whether logical broadcast service information is mapped with a physical channel, based on the broadcast service parameter, and accesses a corresponding physical channel.

Upon acquiring a BCS ID, e.g., BCS2, of a desired broadcast service among BCS IDs BCS1, BCS2, . . . , BCSn for n broadcast services included in the BSPM, the mobile station tunes to a corresponding service frequency f_{BCS2} detected through the BSPM, and then receives broadcast data over a forward broadcast service channel (F_BSCH) at the service frequency. However, if a user of the mobile station desires to stop the broadcast service, the mobile station stops monitoring f_{BCS2} and tunes back to the original frequency band f_{HASH}. In FIG. 3, a shadowed part denotes a time period for which the mobile station is receiving the broadcast service.

Broadcast data provided by a mobile communication system is wirelessly broadcasted using a broadcast channel. In such a broadcast service, the most important characteristic required by a system is to prevent an unauthorized mobile station or a mobile station whose user is not registered as a normal user, from receiving broadcast data. In addition, the mobile station should be able to receive a call request for a voice call service, i.e. a paging signal by the system, even during the broadcast service.

Therefore, the broadcast service system encrypts broadcast data traffic so that it can be decrypted with a predetermined decryption key (i.e. Broadcast Access Key (BAK)), before transmission, and provides the encryption key for decryption of broadcast data traffic to mobile stations that access a broadcast service (BCS) controller to set the broadcast service. For example, a common key having a unique key value for each broadcast service is used as the encryption key, and is updated at long periods, for example, by the month. The common encryption key is transmitted only to the mobile stations authorized to receive the broadcast service, to thereby prevent illegal use and allow the mobile stations to normally receive a call request.

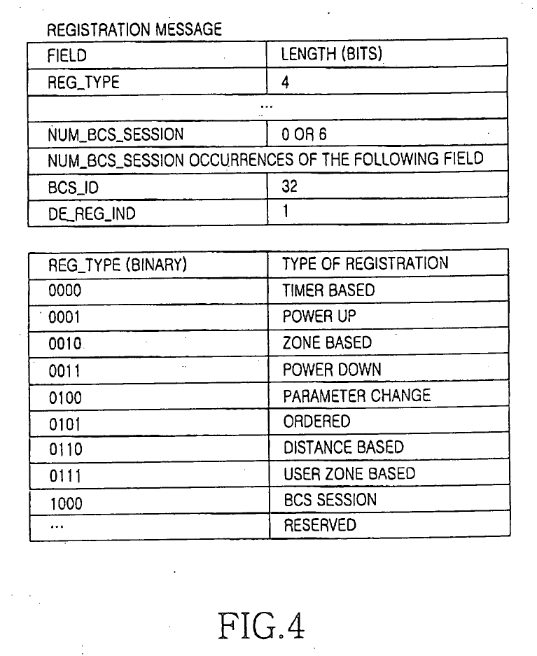

A mobile station should be able to receive a call request for a voice call service, i.e. a paging signal by the system, even during the broadcast service. Additionally, in the broadcast service, location registration can be performed at a fixed time, and the registration information can be used for accounting or other purposes. Therefore, a mobile station in broadcast service periodically transmits a location registration message and receives L2 ACK as a response thereto by a timer set to a designated timer value. The location registration is achieved by transmitting a registration message previously agreed upon between the broadcast service system and the mobile station, to a base station. FIG. 4 illustrates a data format of a registration message transmitted from a mobile station to a base station in a broadcast service system to which the present invention is applied. With reference to FIG. 4, a description will now be made of major fields of the registration message. A REG_TYPE field indicates a cause of location registration, a NUM_BCS_SESSION field indicates the number of sessions set up for a broadcast service, and fields for a broadcast service follows according to the number of the sessions. The fields for a broadcast service include a BCS_ID field indicating the contents of a desired broadcast service and a DE_REG_IND field indicating whether the broadcast service is ended.

Location registration of a mobile station is performed when a predetermined location registration condition such as time-based registration, registration ordered by a paging message from a system, or expiration of a lifetime of the encryption key is satisfied, and the system decides the reason why the mobile station performs location registration, based on the REG_TYPE field in the registration message. Values of the REF_TYPE field will be described in brief. For example, ‘0000’ means that location registration is performed when the mobile station has reached a predetermined location registration period, ‘0001’ means that location registration is performed when the mobile station is powered up, ‘0010’ means that location registration is performed when the mobile station enters a new registration zone, ‘0011’ means that location registration is performed when the mobile station is powered down, ‘0100’ means that location registration is performed when a parameter is changed, ‘0101’ means that location registration is performed when location registration is ordered by the system, ‘0110’ means that location registration is performed when a distance from a base station is changed, ‘0111’ means that location registration is performed when the mobile station enters a new user zone, and ‘1000’ means location registration is performed for initiating or holding the broadcast service.

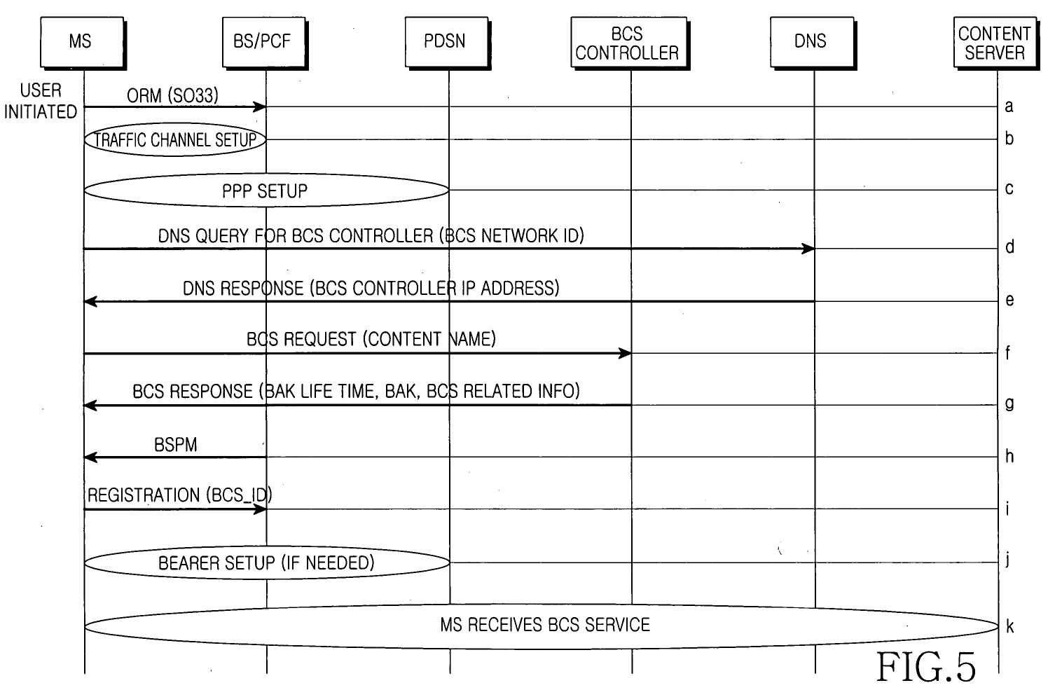

FIG. 5 is a message flow diagram illustrating a broadcast service procedure provided in a broadcast service system to which the present invention is applied. Herein, some processes such as authentication, unrelated to the present invention, are omitted or illustrated in brief.

Referring to FIG. 5, as it initiates a broadcast service, a mobile station transmits an origination message (ORM) including a service option (SO) number 33 (SO33) indicating a data service to a base station in step (a), sets up a traffic channel in step (b), and then sets up PPP connection to a Packet Data Service Node (PDSN) in step (c). In step (d), the mobile station inquires of a Domain Name System (DNS) server about an IP address of a broadcast service (BCS) controller using address information of the DNS server acquired through the PPP connection, and in step (e), the mobile station receives an IP address of the BCS controller from the DNS server.

In step (f), the mobile station sends an information request for a broadcast service desired by a user to the BCS controller, and in step (g), the BCS controller performs authentication on the mobile station and then provides information necessary for receiving a broadcast service (hereinafter referred to as “broadcast reception information”). The broadcast reception information includes common encryption key (or Broadcast Access Key (BAK)) information for reception of broadcast data, a lifetime of the common encryption key, a multicast IP address, and port information.

After receiving the broadcast reception information, the mobile station receives in step (h) a Broadcast Service Parameter Message (BSPM) from the base station over an overhead channel and acquires information on a traffic channel corresponding to a broadcast service available in the base station. Thereafter, in step (i) the mobile station transmits a registration message shown in FIG. 4 to the base station using the broadcast service, and starts receiving the broadcast service. If the broadcast service was requested for the first time, the base station performs a bearer setup process in step (j). If a channel for the requested broadcast service has already been set up, the step (j) is not necessary. Thereafter, in step (k), the mobile station receives a corresponding broadcast service, and allows reception of a BSPM message for the lifetime of the common encryption key and reception of the broadcast service only through transmission of a registration message.

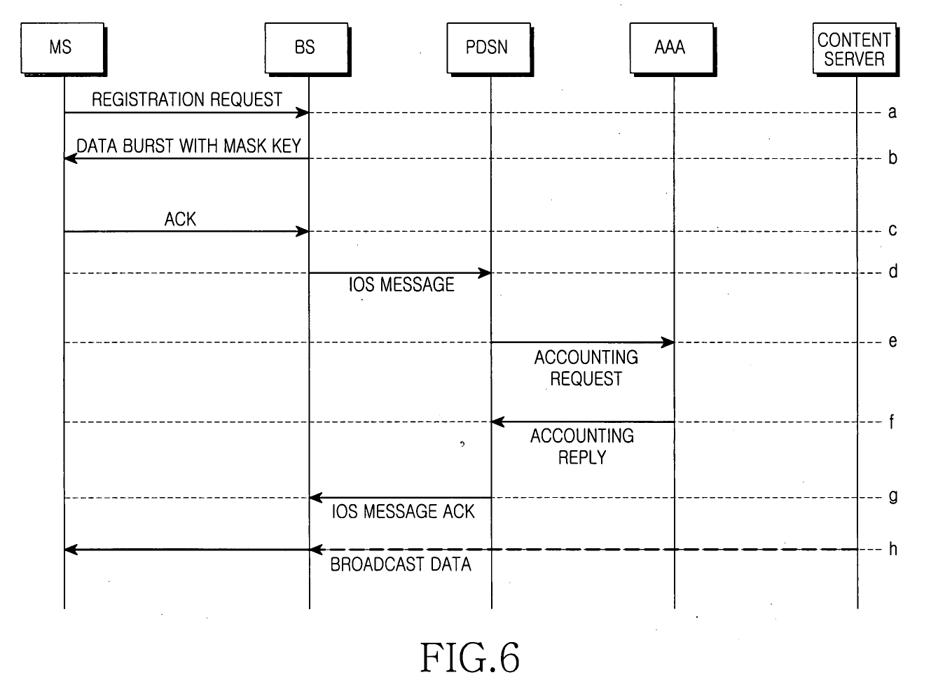

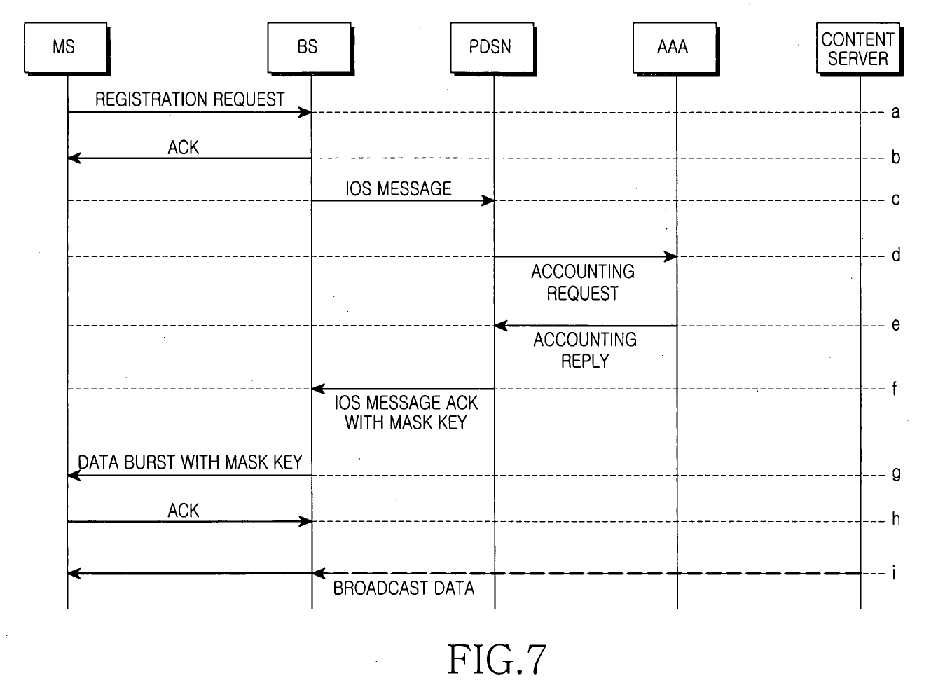

Since the encryption key used in a system providing the broadcast service shown in FIG. 5 is a common key which is provided to all mobile stations receiving the broadcast service and updated at long periods, flat-rate accounting synchronized with an encryption key update period is possible but time-based counting is impossible. Therefore, a broadcast service for which time-based accounting is possible by registration of a mobile station as shown in FIGS. 6 and 7 has been proposed.

FIG. 6 is a message flow diagram illustrating a procedure for registering a mobile station by a base station in a broadcast service system to which the present invention is applied. It is assumed herein that a mobile station has already received broadcast service parameters necessary for connecting a session to a content server, from the content server through a BSPM message. In the procedure of FIG. 6, encryption and decryption of broadcast data are performed through the above-stated common encryption key, a mask key stated below, and a random seed masked by the mask key.

The common encryption key is updated at long periods, while the mask key is updated at short periods by time-based accounting. Both keys are unicast to a mobile station. The masked random seed is broadcasted together with broadcast data transmitted to the mobile station. In addition, the mobile station acquires a random seed by XORing the masked random seed and a mask key received from a base station, and decrypts received broadcast data using both the random seed and the common encryption key.

It will be assumed herein that encryption/decryption of broadcast data is performed simply using the mask key, for the convenience of explanation.

Referring to FIG. 6, in step (a), a mobile station transmits a registration message to a base station in order to request a broadcast service. A format of the registration message has been described with reference to FIG. 4. The registration message is used to register a location of the mobile station in the broadcast service system, and at the same time, forward a type of a desired broadcast service to the base station. In addition, the registration message is used to request the base station to transmit a mask key for a broadcast service. A location of the mobile station is determined by an identifier (ID) of a base station that receives the registration message and forwards the received registration message to the system, and a type of the broadcast service the mobile station desires to receive is determined by a BCS_ID field included in the registration message.

In step (b), upon receiving the registration message including the BCS_ID field from the mobile station for the first time, the base station, determining that a broadcast service request is received from the mobile station, generates a mask key required at the current time for encryption/decryption of a broadcast service corresponding to the BCS_ID, and transmits the generated mask key through a data burst message (DBM) or an encryption information message (EIM) over a paging channel (PCH) or a forward common control channel (F-CCCH). At the same time, the base station sends location information of the mobile station to an exchange (not shown) or an AAA server for location registration. The common encryption key and the mask key are transmitted at different points. For example, the common encryption key having a relatively large number of bits is transmitted for a long period so that it does not affect system congestion, while the mask key used together with the common encryption key for decryption of broadcast data is transmitted from the base station at each location registration of the mobile station.

That is, in the procedure of FIG. 6, broadcast data traffic is encrypted before being transmitted so that it can be decrypted only when a mask key having a predetermined lifetime is used together with the common encryption key, and the mask key for decryption of the broadcast data traffic is provided to a corresponding mobile station each time location registration is performed periodically or aperiodically on mobile stations during the broadcast service. This is to perform time-based accounting on mobile stations that have normally transmitted the registration message of FIG. 4 without providing a broadcast service to the mobile stations that did not transmit the registration message, by forcing mobile stations receiving the broadcast service to perform location registration.

In this regard, the data burst message or the encryption information message selectively carries the mask key itself, generation information, i.e. a seed, used to generate the mask key, and a lifetime of the mask key. In another case, the mask key can be generated not by the base station but by a separate entity and then provided to the base station. In FIG. 6, the mask key has a predetermined lifetime.

In step (c), if the mobile station successfully receives the mask key or successfully generate the mask key by receiving the seed, it transmits an acknowledge (ACK) message to the base station. In step (d), if the ACK message is received from the mobile station, the base station transmits time stamp information of the mobile station, being set to the current time, and the BCS_ID to a Packet Data Service Node (PDSN) using an inter-operability specification (IOS) message, determining that the mask key has been successfully received. If a response to the data burst message including the mask key is not received from the mobile station, the base station retransmits a data burst message including the mask key a predetermined number of times until the response is received from the mobile station.

In step (e), the packet data service node transmits broadcast service access time information, i.e. accounting information, for each mobile station to the AAA server using an accounting request message in response to the IOS message. In step (f), the AAA server stores the accounting information and transmits an accounting reply message to the packet data service node. In step (g), the packet data service node transmits an ACK message for the IOS message to the base station to inform the base station that an accounting process has been performed.

In step (h), the base station encrypts broadcast data received from the content server via the packet data service node using the mask key, and transmits the encrypted broadcast data to the mobile station over a broadcast service channel. Then the mobile station decrypts the broadcast data with the received mask key.

So far, a description has been made of a procedure for generating a mask key for a broadcast service and encrypting the broadcast data in a base station. In another case, such an operation can be performed in the packet data service node as illustrated in FIG. 7.

FIG. 7 is a message flow diagram illustrating a procedure for registering a mobile station through a packet data service node in a broadcast service system to which the present invention is applied. It is assumed herein that a mobile station has already received broadcast service parameters necessary for connecting a session to a content server from the content server through a BSPM message.

Referring to FIG. 7, in step (a), a mobile station transmits a registration message to a base station in order to request a broadcast service. A format of the registration message has been described with reference to FIG. 4. The registration message is used to register a location of the mobile station in the broadcast service system, and at the same time, forward a type of a desired broadcast service to the base station. In addition, the registration message is used to request a mask key for a broadcast service. A location of the mobile station is determined by an ID of a base station that receives the registration message and forwards the received registration message to the system, and a type of broadcast service the mobile station desires to receive is determined by a BCS_ID field included in the registration message.

In step (b), if a registration message including BCS_ID is received from the mobile station for the first time, the base station, determining that a broadcast service request is received from the mobile station, automatically responds with an ACK message and, at the same time, sends location information of the mobile station to an exchange (not shown) or an AAA server for location registration. In step (c), the base station transmits time stamp information of the mobile station, being set to the current time, and the BCS_ID to a Packet Data Service Node (PDSN) using an IOS message.

In step (d), the packet data service node transmits broadcast service access time information, i.e. accounting information, for each mobile station to the AAA server using an accounting request message in response to the IOS message. In step (e), the AAA server stores the accounting information and transmits an accounting replay message to the packet data service node.

After the accounting process is completed, in step (f), the packet data service node generates a mask key valid at the current time for a broadcast service corresponding to the BCS_ID, and transmits information on the mask key to the base station using an ACK message indicating that the accounting process has been successfully performed. The packet data service node can transmit the mask key itself or generation information, i.e. seed, used to generate the mask key.

In step (g), the base station transmits the mask key or the generation information received from the packet data service node to the mobile station using a Data Burst Message (DBM) or an Encryption Information Message (EIM). In FIG. 7, the mask key has a predetermined lifetime. Likewise, the data burst message or the encryption information message includes the mask key or the generation information, and optionally includes a lifetime of the mask key.

In step (h), the mobile station transmits an ACK message to the base station to indicate successful receipt of the mask key, if it has successfully received the mask key or successfully generated the mask key by receiving the generation information. If a response to the data burst message containing the mask key is not received from the mobile station, the base station retransmits a data burst message containing the mask key a predetermined number of times until a response thereto is received from the mobile station. In step (i), the base station (or base station controller) encrypts broadcast data received from the content server with the mask key and transmits the encrypted broadcast data to the mobile station. Then the mobile station decrypts the broadcast data with the received mask key.

That is, the base station transmits the mask key provided from the packet data service node to the mobile station in response to the registration message from the mobile station. Further, the base station encrypts the broadcast data provided from the content server and transmits the encrypted broadcast data to the mobile station.

As described above, the base station or the packet data service node transmits a mask key used to encrypt current broadcast data, or generation information for the mask key and a lifetime of the mask key, for each registration message transmitted by the mobile station.

In addition, the mobile station, having received the mask key or generated the mask key through the generation information, should perform a new registration process before expiration of a lifetime of the mask key in order to continuously receive the broadcast service. Upon receiving a registration message from the mobile station, the base station updates accounting information from the AAA server through the packet data service node to enable time-based accounting by the lifetime of the mask key.

In the time-based accounting method described above, communication for accounting between a Base Station/Packet Control Function Block (BS/PCF), a Packet Data Service Node (PDSN), and an AAA server and transmission of a mask key are performed for each registration message transmitted by a mobile station. All mobile stations receiving a broadcast service transmit registration messages periodically or aperiodically while receiving the broadcast service, and when an accounting process and a mask key transmission operation are performed for each registration message, heavy traffic occurs as a whole. In addition, at a point where a new mask key is used after expiration of a lifetime of a specific mask key, all mobile stations receiving a broadcast service register their locations in a base station in order to receive a new mask key, and for this, the base station must transmit a new mask key, undesirably causing congestion.

Therefore, the registration procedure for updating, by the base station, accounting information for two or more registration messages repeatedly received from one mobile station within a lifetime of a mask key and repeatedly transmitting the same mask key is unnecessary. Further, if transmission of a new mask key is concentrated at a boundary point where a lifetime of the mask key expires as stated above, system congestion occurs and a broadcast service for mobile stations having failed to receive a new mask key within the lifetime is temporarily suspended. Accordingly, a method for preventing this problem is required.

The present invention has been proposed to resolve the above problem, and a broadcast service method according to an embodiment of the present invention and a system therefor will be described with reference to FIGS. 8 to 16.

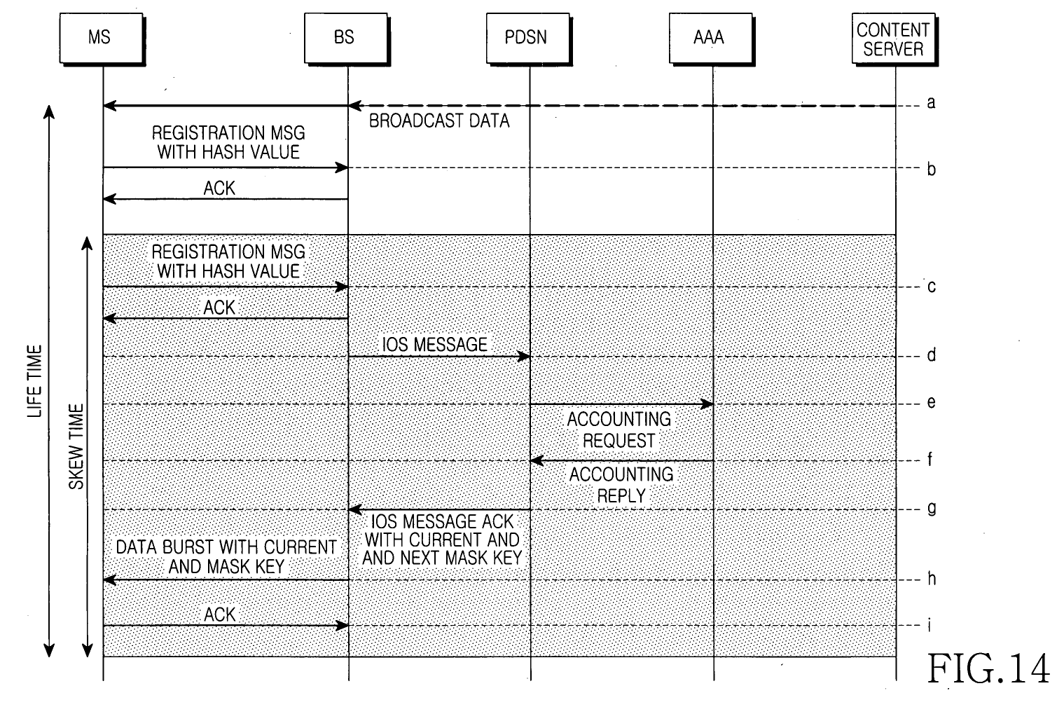

In the following description, the present invention is roughly divided into a first embodiment for reducing congestion due to repeated accounting and mask key updating operations, and a second embodiment for reducing congestion due to concentrated transmission of a mask key at a boundary point of a lifetime for which the mask key continues. The following description first presents a basic idea of the present invention, describes the first embodiment with reference to FIGS. 8 to 13, and then describes the second embodiment with reference to FIGS. 14 to 16.

In the first embodiment of the present invention, a mobile station defines encryption information, i.e. a mask key (or generation information for the mask key), and a lifetime of the mask key transmitted by a base station in response to a registration message, as a registration identifier (ID). The generated registration ID is transmitted to the base station along with a next registration message transmitted by the mobile station. Upon receiving the registration message including the registration ID, the base station determines whether the registration ID is for previously transmitted encryption information. If the received registration ID is identical to the encryption information previously transmitted by the base station, the base station omits all procedures necessary for accounting information updating and encryption information updating for the mobile station, to thereby reduce system congestion.

In the second embodiment of the present invention, a base station defines a predetermined time period before a point where a lifetime of a mask key expires as a skew time, and transmits encryption information to be used next or transmits current encryption information together with next encryption information so that a broadcast service can be continuously used with a mobile station that transmitted a registration message. A transmission point of the registration message within the skew time is randomly set on the basis of an initial location registration time of each mobile station. As a result, system congestion due to concurrent registration message transmissions by mobile stations and concentrated transmission of a mask key by a base station is reduced.

A detailed description will now be made of the first embodiment in which the mask key is used as a registration ID. In the present invention, it is assumed that a mobile station periodically or aperiodically receives a common encryption key that is calculated together with the mask key through a base station and used for decryption of broadcast data.

In this embodiment, a registration ID included in a registration message can be generated in various manners, and it is assumed herein that related information of a mask key is used as the registration ID. The related information of a mask key includes a mask key itself, generation information (i.e. a seed) for the mask key, and a hash value of the mask key. Upon receiving a registration message from a mobile station, a base station determines whether a mask key or related information included in the registration message is identical to related information of a currently valid mask key, to determine whether it is necessary to transmit accounting and encryption information.

When a mobile station generates a hash value from a mask key and transmits the generated hash value using a registration message, transmission efficiency is higher than when the mobile station inserts a mask key itself having a relatively large size or generation information for the mask key into the registration message before transmission, because the hash value generally has a shorter length (smaller number of bits) than an input value. As is well known, a hash function used for generating the hash value is characterized in that it is difficult to find an input value for a result value and it is also difficult to find different input values having the same result value. Therefore, when a mobile station has transmitted a hash value of a mask key, a base station can determine whether the hash value is identical to a hash value of the current mask key, with sufficiently high probability.

Equation (1) below shows an example of a representative hash function using a modulo operation. Various known hash functions can be used as the hash function.

f(x)=x mod 16 (1)

Equation (1) defines a hash function for generating a 4-bit hash value from an 8-bit mask key. In Equation (1), ‘x’ denotes a received mask key or a mask key generated using a received seed, and ‘f(x)’ denotes a value corresponding to the ‘x’ and is a 4-bit hash value.

FIG. 8 illustrates a format of a registration message including related information of a mask key according to an embodiment of the present invention. Herein, a mask key is comprised of 8 bits, and a 4-bit hash value is used as related information of a mask key. When a MASK_KEY_HASH_INCL field has a value of ‘1’, a hash value of a mask key is transmitted from a mobile station to a base station through a MASK_KEY_HASH field.

When a mobile station transmits a hash value of a mask key, it is possible to reduce a length of a registration message using a registration ID comprised of a smaller number of bits, compared with when the mobile station transmits a mask key or generation information for the mask key. However, there is a probability, though it is low, that collision between hash values will occur. That is, a mobile station and a base station can generate the same hash value using different mask keys. In this case, the base station determines that the mobile station already has a valid mask key, but the mobile station cannot receive broadcast data because it does not know a currently valid mask key. In order to prevent such a case, a packet data service node generates a mask key by selecting a mask key having a different hash value from that of the previously used mask key.

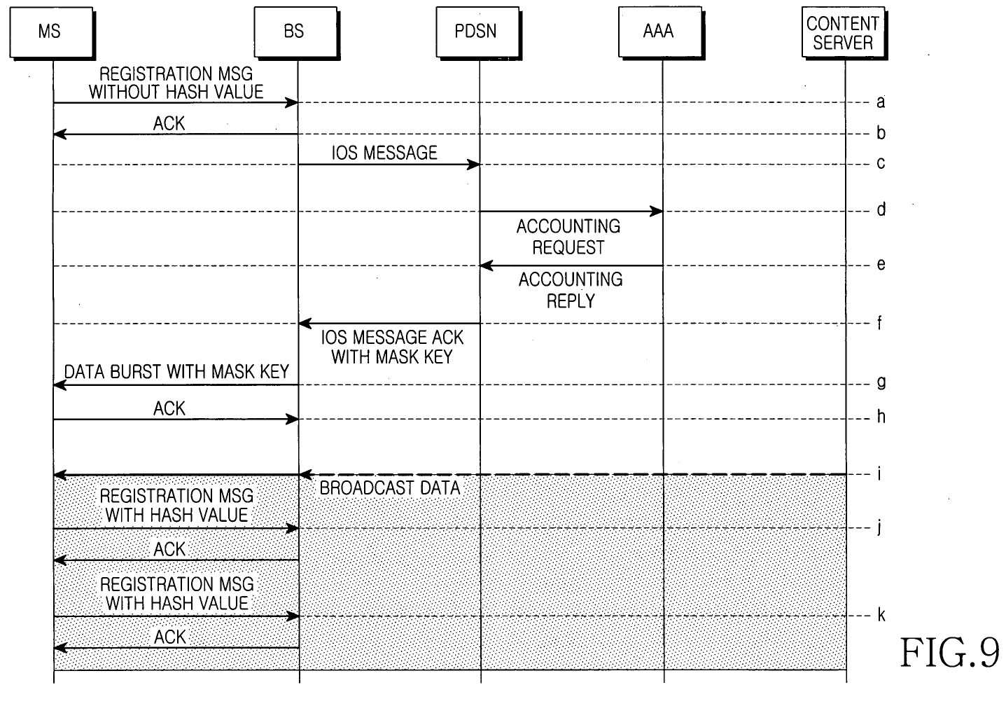

FIG. 9 is a message flow diagram illustrating a broadcast service procedure for registering a mobile station using a hash value of a mask key according to an embodiment of the present invention. Herein, it is assumed that a mask key for a broadcast service is generated by a packet data service node, and a base station stores the mask key generated by the packet data service node and determines whether to transmit accounting information and a mask key based on a registration message received from a mobile station. In addition, it is assumed that the mobile station has already received and stored broadcast service parameters necessary for connecting a session to a content server from the content server through a BSPM message.

Referring to FIG. 9, in step (a), a mobile station transmits a first registration message to a base station in order to request a broadcast service. The first registration message does not include a registration ID because it is used to register a location of the mobile station in a broadcast service system and request a broadcast service for the first time. A format of the registration message has already been described with reference to FIG. 4. A location of a mobile station is determined by an ID of a base station that receives the first registration message and transmits the received first registration message to the system, and a type of broadcast service the mobile station desires to receive is determined by a Broadcast Service Identifier (BCS_ID) field included in the registration message.

In step (b), upon receiving the first registration message not including a registration ID from the mobile station, the base station automatically responds with an ACK message and at the same time, sends location information of the mobile station to an exchange (not shown) or an AAA server, for location registration. In step (c), the base station transmits time stamp information of the mobile station, being set to the current time, and the BCS_ID to a Packet Data Service Node (PDSN) using an IOS message.

In step (d), the packet data service node transmits broadcast service access time information, i.e. accounting information, for each mobile station to the AAA server using an accounting request message in response to the IOS message. In step (e), the AAA server stores the accounting information and transmits an accounting reply message to the packet data service node.

After the accounting process is completed, in step (f), the packet data service node generates a mask key valid at the current time for a broadcast service corresponding to the BCS_ID, and transmits the mask key to the base station using an ACK message indicating that the accounting process has been successfully performed. The packet data service node can transmit the mask key itself or generation information used to generate the mask key. In step (g), the base station transmits the mask key or the generation information received from the packet data service node to the mobile station using a Data Burst Message (DBM).

In step (h), the mobile station transmits an ACK message to the base station to indicate successful receipt of the mask key, if it has successfully received the mask key or successfully generated the mask key by receiving the generation information. Here, the mobile station generates a hash value of the mask key as a registration ID corresponding to the received mask key and stores the generated hash value. In step (i), the base station (or base station controller) encrypts broadcast data received from the content server with the mask key and transmits the encrypted broadcast data to the mobile station. Then the mobile station decrypts the broadcast data with the received mask key.

In step (j), the mobile station generates a second registration message and transmits the generated second registration message to the base station in order to perform location registration according to expiration of a periodic registration timer or another registration request condition. Here, the second registration message includes a registration ID indicating a hash value of a mask key generated in step (h) by the mobile station. The base station determines whether to transmit accounting information and a mask key based on the hash value included in the second registration message. That is, the base station determines whether there is any previously received registration ID and whether the registration ID is identical to a previously received registration ID. If the registration ID is identical to a previously received registration ID, the base station disregards the second registration message, determining that more than two registrations have been performed within a lifetime.

Likewise, in step (k), if a third registration message is received within a lifetime, the base station disregards the third registration message. Here, “disregarding the second and third registration messages” means that the base station does not transmit accounting or encryption information in response to the second and third registration messages, and an ACK message is automatically transmitted to the mobile station in response to the second and third registration messages.

In FIG. 9, a time period for which the mobile station receives a broadcast service with the same mask key is represented by a shaded part, and in the shaded part, even though the mobile station transmits additional registration messages, the base station does not transmit accounting information and an additional mask key to a corresponding mobile station.

In a modified embodiment of the present invention, a base station transmits a mask key to a mobile station together with a sequence number assigned to the mask key. Then the mobile station inserts a sequence number of a previously received mask key into a registration message before transmission. If a sequence number of the registration message received from the mobile station is identical to a sequence number of a currently valid mask key, the base station determines that encryption information of the mobile station is still valid. However, if a sequence number of the registration message received from the mobile station is not identical to a sequence number of a valid mask key of the base station, the base station updates accounting information, generates new encryption information, i.e. a new mask key or generation information for the mask key, and transmits the generated new encryption information.

In the modified embodiment of the present invention, a mobile station assigns a sequence number ‘0’ to encryption information received in response to a registration message initially transmitted to receive a broadcast service, and thereafter adds one to a sequence number each time new encryption information is received. The sequence number is inserted into a registration message transmitted to a base station. The base station assigns a sequence number ‘0’ to encryption information transmitted in response to a registration message initially received from the mobile station, and thereafter increases the sequence number (by one) each time new encryption information is transmitted. If a registration message is received from the mobile station, the base station determines whether a sequence number included in the registration message is identical to a sequence number of a corresponding mobile station, to determine validity of a mask key for the corresponding mobile station. The sequence number can be generated such that it reverts to zero (‘0’) when its length exceeds a predetermined value.

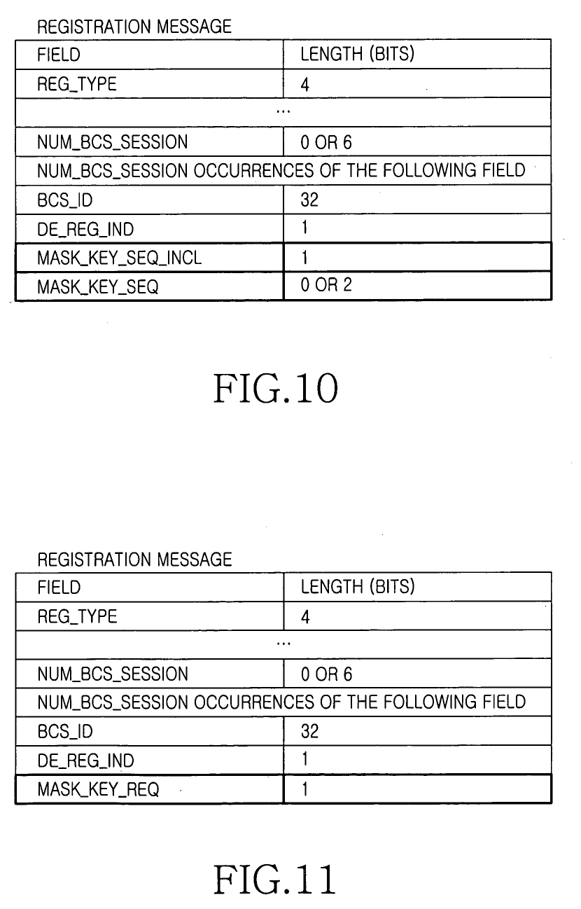

FIG. 10 illustrates a format of a registration message including a sequence number of a mask key according to a modified embodiment of the present invention. Here, a sequence number of a mask key has a length of 2 bits, and can expresses a value between 0 and 3. A sequence number of the mask key is transmitted through a MASK_KEY_SEQ field of a registration message when a MASK_KEY_SEQ_INCL field has a value of ‘1’.

Likewise, a mobile station excludes sequence information of a mask key by setting the MASK_KEY_SEQ_INCL field to ‘0’ when initially transmitting a registration message to receive a mask key, and upon receiving the registration message not including a sequence number of a mask key, a base station transmits currently valid encryption information.

In another modified embodiment of the present invention, a mobile station inserts a mask key request bit field for requesting transmission of encryption information into a registration message initially transmitted to request reception of a broadcast service. Upon receiving a registration message with a mask key request bit being set to ‘1’, a base station transmits a mask key or generation information for the mask key and a lifetime of the mask key to the mobile station, as encryption information. Based on a lifetime of the mask key, the mobile station transmits a registration message with a mask key request bit being set to ‘0’ for the lifetime, and transmits a registration message with a mask key request bit being set to ‘1’ after a lapse of the lifetime. After a broadcast service is started, the base station updates accounting information and transmits encryption information only when a mask key request bit of a registration message received from the mobile station is ‘1’. In this case, it is preferable to transmit the registration message with a mask key request bit being set to ‘1’ before a lapse of the lifetime, leaving a predetermined time margin.

FIG. 11 illustrates a format of a registration message including a mask key request bit according to another modified embodiment of the present invention. As illustrated, a mobile station can request a new mask key through a 1-bit MASK_KEY_REQ field.

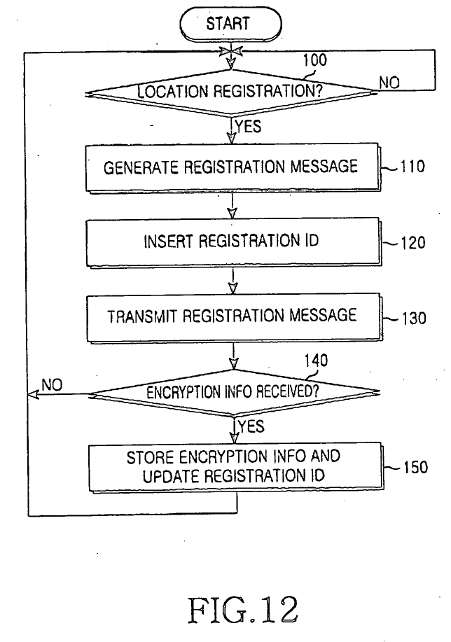

FIG. 12 is a flowchart illustrating a registration procedure by a mobile station using a registration ID according to an embodiment of the present invention. Referring to FIG. 12, a mobile station in broadcast service determines in step 100 whether it has reached a period for location registration or whether it should perform location registration because of satisfaction of a predetermined location registration condition. If it is determined that location registration should be performed, the mobile station generates a registration message in step 110, inserts a registration ID for a currently valid mask key into the registration message in step 120, and transmits the registration message with the registration ID to a base station in step 130. A hash value, or a sequence number, of a mask key or a mask key request bit, stated before, is used as the registration ID.

If encryption information corresponding to the registration message is received in step 140, the mobile station stores the encryption information for a broadcast service and updates the registration ID in step 150. That is, the mobile station generates a new hash value with a mask key included in the encryption information, increases a sequence number by one, or sets a mask key request bit to ‘1’ or ‘0’ according to a lifetime. If it is determined in step 140 that no encryption information is received, the mobile station returns to step 100.

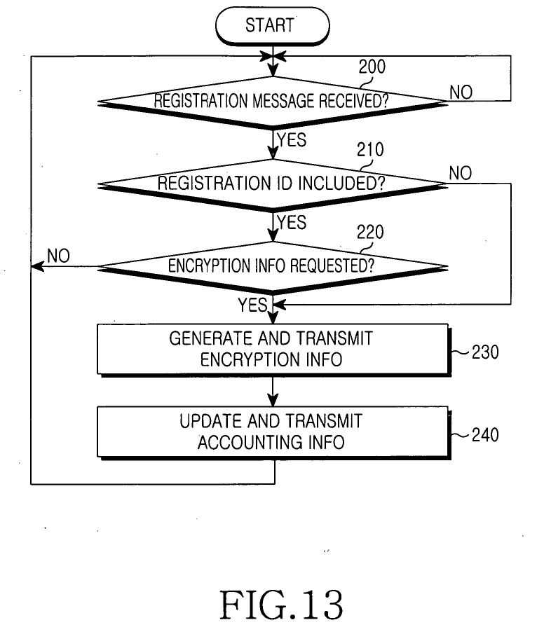

FIG. 13 is a flowchart illustrating a registration procedure by a base station using a registration ID according to an embodiment of the present invention. Referring to FIG. 13, a base station determines in step 200 whether a registration message has been received from a mobile station in broadcast service. If a registration message has been received, the base station determines in step 210 whether a registration ID is included in the received registration message. If a registration ID is included in the received registration message, the base station proceeds to step 220. However, if a registration ID is not included in the registration message because the registration message is an initially transmitted registration message, or if a mask key request bit of FIG. 11 used as a registration ID though not illustrated in FIG. 13 is set to ‘0’, the base station proceeds to step 230.

In step 220, the base station determines whether encryption information is requested by the mobile station, based on the registration ID. That is, if a hash value included in the registration message is not identical to a hash value of a currently valid mask key, if a sequence number included in the registration message is not identical to a sequence number included for a corresponding mobile station, or if a mask key request bit value included in the registration message is ‘1’, the base station proceeds to step 230, determining that new encryption information has been requested. Otherwise, the base station returns to step 200 after transmitting an ACK message to the mobile station.

In step 230, the base station generates encryption information essentially including a currently valid mask key or generation information for the mask key and optionally including a lifetime of the mask key, and transmits the generated encryption information to the mobile station. In step 240, the base station updates accounting information for the mobile station and transmits the updated accounting information to an AAA server via a packet data service node.

As described above, a mobile station decrypts broadcast data using a mask key having a predetermined lifetime. For a continuous broadcast service, the mobile station transmits a registration message for requesting a new mask key before the lifetime of the mask key expires. The registration message includes related information of a mask key, a sequence number and a mask key request bit, as a registration ID stated above. The base station transmits new encryption information to the mobile station in response to the registration message.

Because a mask key is shared by a plurality of mobile stations receiving a broadcast service in a service area of a particular base station within its lifetime, at a boundary point of the lifetime, all mobile stations receiving the broadcast service transmit registration messages and a base station must transmit new encryption information to each of the mobile stations that transmitted the registration messages. Such a process causes concentration of many messages at a certain time, obstructing a normal operation of the system. In order to resolve such a problem, the present invention can also set a skew time before the lifetime of the mask key expires.

A detailed description will now be made of a second embodiment of the present invention for reducing system congestion due to concentrated transmission of a mask key at a boundary point of a lifetime for which the mask key continues, using the skew time.

In this embodiment, a base station sets a skew time to a time longer than a maximum period among registration message transmission periods of all mobile stations receiving a broadcast service in its service area. Then, all of the mobile stations transmit a registration message at least once within the skew time. The base station transmits encryption information including a next mask key together with a currently valid mask key, to a mobile station that transmitted a registration message for a skew time which is a time before a lifetime of a mask key expires. The mobile station can continuously receive broadcast data using the next mask key after a lifetime of the current mask key expires.

FIG. 14 is a message flow diagram illustrating a broadcast service method using a skew time according to a second embodiment of the present invention. Herein, a mobile station has already been receiving broadcast data via a base station, and periodically or aperiodically transmits a registration message including, for example, a hash value of a mask key as a registration ID to the base station.

Referring to FIG. 14, in step (a), a mobile station decrypts broadcast data received via a base station with a currently valid mask key. In step (b), the mobile station generates a first registration message and transmits the generated first registration message to the base station in order to perform location registration according to expiration of a periodic registration timer or another registration request condition. Here, the first registration message includes a registration ID indicating a hash value of the mask key. The base station disregards the first registration message, determining that the first registration message was received before a predetermined skew time and has a hash value of a valid mask key. That is, the base station merely transmits an ACK message to the mobile station, but does not perform a mask key transmission process and an accounting process based on the first registration message.

When a sequence number or a mask key request bit is used as the registration ID, the base station disregards the first registration message according to a sequence number or a mask key request bit included in the first registration message. In another case, if it is determined that the first registration message was received before a predetermined skew time, the base station disregards the first registration message according to a sequence number or a mask key request bit included in the first registration message.

In step (c), if a second registration message is received from the mobile station for a skew time before a lifetime of a current mask key expires, the base station automatically responds with an ACK message and at the same time sends location information of the mobile station to an exchange (not shown) or an AAA server for location registration. In step (d), the base station transmits time stamp information of the mobile station, being set to the current time, and a corresponding BCS_ID to a packet data service node (PDSN) using an IOS message.

In step (e), the packet data service node transmits broadcast service access time information, i.e. accounting information, for each mobile station to the AAA server using an accounting request message in response to the IOS message. In step (f), the AAA server stores the accounting information and transmits an accounting replay message to the packet data service node.

After the accounting process is completed, in step (g), the packet data service node transmits a mask key (or generation information) currently used for a broadcast service corresponding to the BCS_ID and a mask key (or generation information) to be used next time, to the base station using an ACK message indicating that the accounting process has been successfully performed. In step (h), the base station transmits the current and next mask keys received from the packet data service node and information on their lifetimes to the mobile station using a Data Burst Message (DBM) or an Encryption Information Message (EIM). In step (i), the base station receives an ACK message in response thereto.

As described above, the base station updates accounting information for a registration message received from the mobile station and transmits a current mask key and a next mask key to the mobile station, for a skew time. In this manner, the mobile station can continuously receive a broadcast service by using the next mask key after expiration of a lifetime of the current mask key. Since transmission of a registration message is periodically performed beginning at a time at which the mobile station first started the broadcast service, it is considered that the transmission is sufficiently randomized within the skew time. Therefore, it is possible to avoid congestion due to concentrated transmission of registration messages within the skew time.

In the embodiment of the present invention, encryption information containing a next mask key as well as a currently valid mask key is transmitted to a mobile station that transmitted a registration message for a skew time before a lifetime of the mask key expires. In this case, however, because the currently valid mask key has already been transmitted to a mobile station in broadcast service, it is preferable to include only the next mask key in the encryption information before transmission.

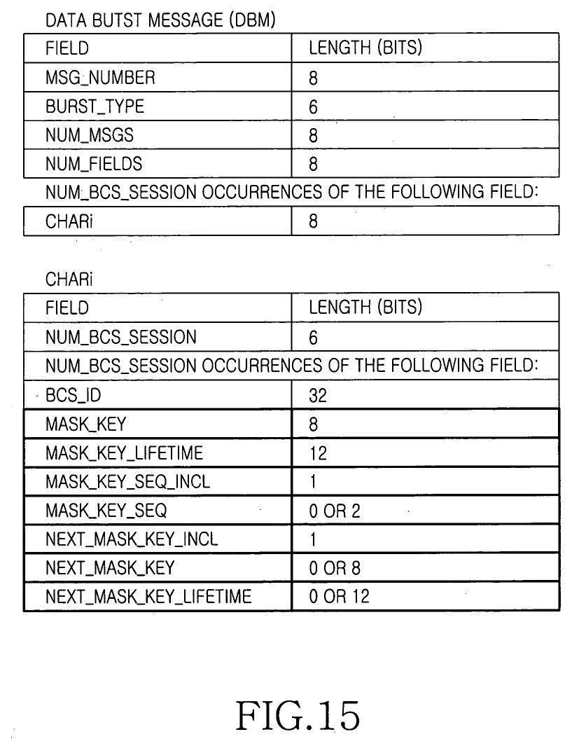

FIG. 15 illustrates a format of a data burst message including a current mask key and a next mask key according to an embodiment of the present invention. With reference to FIG. 15, a description will now be made of major fields of the data burst message. A BURST_TYPE field indicates a type of data included in the data burst message, and a NUM_FIELDS field indicates the number of fields included in the following CHARi filed. When the BURST_TYPE field has a predetermined value indicating a DBM message for transmitting a mask key, the CHARi field has a data structure shown in the lower part of FIG. 15.

In the shown CHARi field, a NUM_BCS_SESSION field indicates the number of sessions connected for a broadcast service, and fields for a broadcast service follow according to the number of sessions. The fields for a broadcast service include a BCS_ID field indicating the contents of a requested broadcast service, a MASK_KEY field indicating a current mask key or generation information for the current mask key, a MASK_KEY_LIFETIME field indicating a lifetime of the current mask key, a NEXT_MASK_KEY_INCL field indicating whether information on the next mask key is included, a NEXT_MASK_KEY field indicating the next mask key or generation information for the next mask key, and a NEXT_MASK_KEY_LIFE_TIME field indicating a lifetime of the next mask key. In addition, when a base station assigns a sequence number to a mobile station as a registration ID, the base station sets the MASK_KEY_SEQ_INCL field of the CHARi field to ‘1’, and transmits the assigned sequence number to the mobile station through the MASK_KEY_SEQ field.

In another case, the BURST_TYPE field is set to a value indicating a type of a common data burst message, and the CHARi field can contain an IP packet transmitted from a packet data service node to a mobile station. In this case, the mobile station analyzes the contents of the IP packet and extracts broadcast service-related information such as current and next mask keys and their lifetimes.

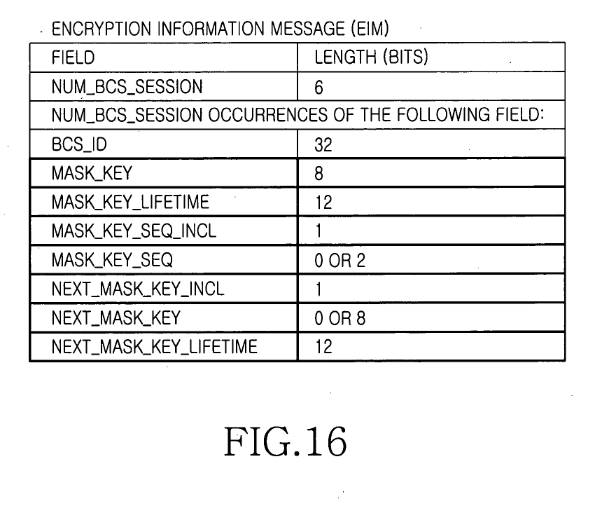

FIG. 16 illustrates a format of an encryption information message including a current mask key and a next mask key according to a second embodiment of the present invention. With reference to FIG. 16, a description will now be made of major fields of the encryption information message. A NUM_BCS_SESSION field indicates the number of sessions connected for a broadcast service, and fields for a broadcast service follow according to the number of sessions. The fields for a broadcast service include a BCS_ID field indicating the contents of a requested broadcast service, a MASK_KEY field indicating a current mask key or generation information for the current mask key, a MASK_KEY_LIFETIME field indicating a lifetime of the current mask key, a NEXT_MASK_KEY_INCL field indicating whether information on a next mask key is included, a NEXT_MASK_KEY field indicating the next mask key or generation information for the next mask key, and a NEXT_MASK_KEY_LIFE_TIME field indicating a lifetime of the next mask key.

Likewise, when a base station assigns a sequence number to a mobile station as a registration ID, the base station sets the MASK_KEY_SEQ_INCL field to ‘1’, and transmits the assigned sequence number to the mobile station through the MASK_KEY_SEQ field.

Meanwhile, in the first and second embodiments, encryption information, i.e. a mask key or generation information for the mask key, and lifetime information of the mask key are generated in a packet data service node, and encryption information generated by a base station is transmitted to a mobile station. However, it is also possible to collectively manage generation and transmission of encryption information in the base station while maintaining a format of each of the messages proposed in the present invention.

As understood from the foregoing description, the present invention prevents deterioration in system performance due to unnecessary mask key transmission and accounting processes in transmitting a mask key for a broadcast service for location registration of a mobile station and performing an accounting operation. In addition, the present invention can prevent transmissions of registration messages by mobile stations from being concentrated just before a lifetime of a mask key expires.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. In a mobile communication system for providing a broadcast service to a plurality of mobile stations over a radio channel, wherein broadcast data is encrypted with predetermined encryption information and provided to the mobile station, a method for receiving a broadcast service in the mobile station, comprising the steps of:
generating a registration message including a predetermined registration identifier for identification of the encryption information, and transmitting the generated registration message to a base station;
receiving updated encryption information for decryption of the broadcast data from the base station; and
updating the registration identifier based on the updated encryption information.

2. The broadcast service method of claim 1, wherein the predetermined encryption information includes at least one of a predetermined mask key required for decryption of the broadcast data, generation information for the mask key, and a lifetime of the mask key.

3. The broadcast service method of claim 2, wherein the registration identifier includes a hash value determined by applying a hash function to a corresponding mask key each time the mask key is updated.

4. The broadcast service method of claim 2, wherein the registration identifier includes a sequence number sequentially assigned to a corresponding mask key each time the mask key is updated.

5. The broadcast service method of claim 1, wherein the registration message is a message that is transmitted from the mobile station to the base station for a predetermined time while the mobile station is using a broadcast service.

6. The broadcast service method of claim 1, wherein the encryption information is generated by a packet data service node and transmitted to the mobile station via the base station.

7. The broadcast service method of claim 1, wherein the encryption information is generated by the base station and transmitted to the mobile station.

8. The broadcast service method of claim 1, wherein the step of receiving updated encryption information is performed when a registration identifier transmitted by the mobile station is identical to a registration identifier currently valid in the base station.

9. In a mobile communication system for providing a broadcast service to a plurality of mobile stations over a radio channel, a method for providing by a base station a broadcast service to the mobile station, comprising the steps of:
receiving a registration message transmitted from the mobile station;
determining whether a registration identifier for identification of encryption information required for decryption of broadcast data is included in the registration message, and determining whether it is necessary to transmit updated encryption information to the mobile station; and
transmitting the updated encryption information to the mobile station according to the determination result.

10. The broadcast service method of claim 9, wherein the predetermined encryption information includes at least one of a predetermined mask key required for decryption of the broadcast data, generation information for the mask key, and a lifetime of the mask key.

11. The broadcast service method of claim 10, wherein the registration identifier includes a hash value determined by applying a hash function to a corresponding mask key each time the mask key is updated.

12. The broadcast service method of claim 10, wherein the registration identifier includes a sequence number sequentially assigned to a corresponding mask key each time the mask key is updated.

13. The broadcast service method of claim 9, further comprising performing an accounting process on the mobile station through a packet data service node when the base station transmits updated encryption information to the mobile station.

14. The broadcast service method of claim 9, further comprising holding a current state of the mobile station for a predetermined lifetime of the encryption information when the registration identifier of the mobile station is identical to a registration identifier available in the base station.

15. The broadcast service method of claim 9, wherein the step of transmitting updated encryption information is performed when the registration identifier of the mobile station is identical to a registration identifier currently valid in the base station.

16. The broadcast service method of claim 9, further comprising transmitting a predetermined response message to the mobile station in response to the registration message if it is determined that transmission of the updated encryption information is not necessary.

17. In a mobile communication system for providing a broadcast service to a plurality of mobile stations over a radio channel, wherein broadcast data is encrypted with predetermined encryption information and provided to the mobile station, a method for receiving a broadcast service in the mobile station, comprising the steps of:
generating a registration message including a predetermined mask key request bit for requesting transmission of the predetermined mask key for decryption of broadcast data and transmitting the generated registration message to a base station while the mobile station is using a broadcast service; and
receiving the encryption information including the predetermined mask key and lifetime information of the predetermined mask key from the base station based on the mask key request bit.

18. The broadcast service method of claim 17, further comprising generating another registration message for requesting a new mask key and transmitting the generated registration message to the base station if the lifetime of the mask key has expired.

19. In a mobile communication system for providing a broadcast service to a plurality of mobile stations over a radio channel, a method for providing by a base station a broadcast service to the mobile station, comprising the steps of:
receiving a registration message including a predetermined mask key request bit for requesting transmission of the predetermined mask key for decryption of broadcast data, from the mobile station;
analyzing a value of the predetermined mask key request bit to determine whether to transmit the encryption information including the predetermined mask key and lifetime information of the predetermined mask key; and
transmitting the encryption information to the mobile station when the base station determines to transmit the encryption information.

20. In a mobile communication system for providing a broadcast service to a plurality of mobile stations over a radio channel, wherein broadcast data is encrypted with predetermined encryption information and provided to the mobile station, a method for receiving a broadcast service in the mobile station, comprising the steps of:
generating a registration message for use of a broadcast service and transmitting the generated registration message to the base station within a predetermined skew time before a lifetime of current encryption information expires;
receiving the current encryption information and next encryption information including their lifetimes from the base station in response to the registration message; and
continuously decrypting the broadcast data using the next encryption information when the lifetime of the current encryption information expires.

21. The broadcast service method of claim 20, wherein the predetermined skew time is set to a time longer than a maximum period among registration message transmission periods of all mobile stations receiving a broadcast service in a service area of the base station.

22. In a mobile communication system for providing a broadcast service to a plurality of mobile stations over a radio channel, a method for providing by a base station a broadcast service to the mobile station, comprising the steps of:
receiving a registration message for use of a broadcast service by the mobile station; and
transmitting current encryption information and next encryption information including their lifetimes to the mobile station if it is determined that the registration message was received within a predetermined skew time before the lifetime of the current encryption information expires.

23. The broadcast service method of claim 22, wherein the skew time is set to a time longer than a maximum period among registration message transmission periods of all mobile stations receiving broadcast service in a service area of the base station.

24. In a mobile communication system for providing a broadcast service to a plurality of mobile stations over a radio channel, a method for providing by a base station a broadcast service to the mobile station, comprising the steps of:
receiving a predetermined registration message for use of a broadcast service by the mobile station; and
transmitting next encryption information following current encryption information to the mobile station if it is determined that the registration message was received within a predetermined skew time before a lifetime of the current encryption information expires.

25. In a mobile communication system including a base station for providing a broadcast service to a plurality of mobile stations over a radio channel and a packet data service node for connecting the base station to a content server via a packet data network, wherein broadcast data is encrypted with predetermined encryption information and provided to the mobile station, a broadcast service method comprising the steps of:
transmitting, by the mobile station, a first registration message for initial use of a broadcast service to the base station;
upon receiving the first registration message, transmitting by the base station encryption information for decryption of broadcast data to the mobile station;
upon receiving the encryption information, generating by the mobile station a registration identifier which includes identification information of the encryption information;
generating by the mobile station a second registration message including the registration identifier and transmitting the generated second registration message to the base station if second or later registration for use of the broadcast service by the mobile station is required;
comparing by the base station the registration identifier included in the second registration message with a registration identifier of encryption information currently registered in the base station; and
transmitting updated encryption information to the mobile station.

26. The broadcast service method of claim 25, further comprising requesting by the base station an accounting process on the mobile station through the packet data service node if the registration identifiers are different.

27. The broadcast service method of claim 25, further comprising holding by the base station the current encryption information of the mobile station and deferring an accounting process on the mobile station if the registration identifiers are identical.

28. The broadcast service method of claim 25, wherein the encryption information includes at least one of a predetermined mask key required for decryption of the broadcast data, generation information for the mask key, and a lifetime of the mask key.

29. The broadcast service method of claim 28, wherein the registration identifier includes a hash value determined by applying a hash function to a corresponding mask key each time the mask key is updated.

30. The broadcast service method of claim 28, wherein the registration identifier includes a sequence number sequentially assigned to a corresponding mask key each time the mask key is updated.

31. A broadcast service system including a base station for providing a broadcast service to a plurality of mobile stations over a radio channel and a packet data service node for connecting the base station to a content server via a packet data network, wherein broadcast data is encrypted with predetermined encryption information and provided to the mobile station, the system comprising:
at least one mobile station connected to the base station through the radio channel, for performing location registration for use of a broadcast service, decrypting the broadcast data using the predetermined encryption information transmitted via the base station while using the broadcast service, generating a registration identifier as identification information of the encryption information, and transmitting the generated registration identifier to the base station; and
at least one base station for transmitting to the mobile station broadcast data transmitted via the packet data service node while the mobile station is using the broadcast service, receiving a predetermined registration message transmitted during location registration of the mobile station, analyzing a registration identifier of the predetermined encryption information included in the registration message, and determining whether to update the predetermined encryption information for the mobile station according to the analysis result.

32. The broadcast service system of claim 31, wherein the registration identifier includes a hash value determined by applying a hash function to a corresponding mask key each time the mask key is updated.

33. The broadcast service system of claim 31, wherein the registration identifier includes a sequence number sequentially assigned to a corresponding mask key each time the mask key is updated.

34. The broadcast service system of claim 31, wherein the base station performs an accounting process on the mobile station through the packet data service node when the base station transmitted updated encryption information to the mobile station.

35. The broadcast service system of claim 32, wherein the base station receives a registration message including a predetermined mask key request bit for requesting transmission of the mask key from the mobile station while the mobile station is using a broadcast service, and transmitting predetermined encryption information including the mask key and lifetime information of the mask key to the mobile station if the mask key request bit has a predetermined bit value.

36. The broadcast service system of claim 31, wherein the encryption information can be used for decryption of the broadcast data only for a predetermined lifetime, wherein the base station transmits to the mobile station both current encryption information and next encryption information including their lifetimes if it is determined that a registration message of the mobile station was received within a predetermined skew time before a lifetime of current encryption information expires, wherein the mobile station decrypts the broadcast data using the next encryption information when the lifetime of the current encryption information expires.
